(19) United States
(12) Patent Application Publication
(10) Pub. No.: US 2013/0004036 A1
(43) Pub. Date: Jan. 3, 2013

(54) Systems And Methods For Customizing Pregnancy Imagery

(76) Inventors: Suzana Apelbaum, New York, NY (US); Serena Amelia Connelly, Brooklyn, NY (US); Shachar Gillat Scott, Hoboken, NJ (US)

(21) Appl. No.: 13/463,912

(22) Filed: May 4, 2012

Related U.S. Application Data
(60) Provisional application No. 61/501,997, filed on Jun. 28, 2011.

(51) Int. Cl. G06K 9/46

(52) U.S. Cl. 382/128

(57) ABSTRACT

Included are embodiments for customizing pregnancy imagery. Some embodiments include receiving pregnancy calendar data of a pregnant woman, the pregnancy calendar data indicating a stage of development of a fetus, selecting, based on the pregnancy calendar data, an image of the fetus associated with the stage of development of the fetus, and receiving a real-time image of the pregnant woman from an image capture device. Embodiments also include determining an orientation of the image of the fetus with respect to the pregnant woman, inserting the image of the fetus into the real-time image of the pregnant woman, wherein the image of the fetus has substantially the same orientation as the real-time image of the pregnant woman and providing the real-time image of the pregnant woman with the image of the fetus to a display device for display.

### CROSS REFERENCE TO RELATED APPLICATION

This application claims the benefit of U.S. Provisional Application No. 61/501,997, filed Jun. 28, 2011, which is herein incorporated by reference in its entirety.

### FIELD OF THE INVENTION

The present application relates generally to customizing pregnancy imagery and specifically to providing imagery of a pregnant woman and imagery of a fetus.

### BACKGROUND OF THE INVENTION

As computing devices become more powerful, users often desire more functionality with those computing devices. As an example, parents often wish to teach their children and others about their pregnancy. However, many current solutions, such as books, videos, video games, etc. often do not adequately illustrate the current state of a pregnant woman, or they do so generically for a “typical” woman at various stages of pregnancy. As such, many parents are left without an adequate mechanism by which to display to themselves and others, customized features about their pregnancy.

### SUMMARY OF THE INVENTION

Included are embodiments of a method for customizing pregnancy imagery. Some embodiments include receiving pregnancy calendar data of a pregnant woman, the pregnancy calendar data indicating a stage of development of a fetus, selecting, based on the pregnancy calendar data, an image of the fetus associated with the stage of development of the fetus, and receiving a real-time image of the pregnant woman from an image capture device. Some embodiments also include determining an orientation of the image of the fetus with respect to the pregnant woman, inserting the image of the fetus into the real-time image of the pregnant woman, where the image of the fetus has substantially the same orientation as the real-time image of the pregnant woman and providing the real-time image of the pregnant woman with the image of the fetus to a display device for display.

Also included are embodiments of a system. Some embodiments of the system include an image capture device, a display device and a memory component. Some embodiments of the memory component store logic that when executed by the system, causes the system to receive pregnancy calendar data of a pregnant woman, the pregnancy calendar data indicating a stage of development of a fetus, select, based on the pregnancy calendar data, an image of the fetus associated with the stage of development of the fetus, and receive an image of the pregnant woman from the image capture device. In some embodiments, the logic further causes the system to determine a relative size of the image of the fetus with regard to the image of the pregnant woman, determine an orientation of the image of the fetus with respect to the pregnant woman, and insert the image of the fetus into the image of the pregnant woman, where the image of the fetus has substantially the same orientation as the image of the pregnant woman, and where the relative size of the image of the fetus is such that the image of the fetus fits inside the image of the pregnant woman. Similarly, in some embodiments, the logic causes the system to provide the image of the pregnant woman with the image of the fetus to the display device for display.

Also included are embodiments of a non-transitory computer-readable medium. Some embodiments of the non-transitory computer-readable medium include a program that causes a computing device to receive the corresponding image of the fetus, receive an image of the pregnant woman from the image capture device, and determine an orientation of the corresponding image of the fetus with respect to the pregnant woman, and insert the image of the corresponding image of the fetus into the image of the pregnant woman. The corresponding image of the fetus may have substantially the same orientation as the image of the pregnant woman, and the corresponding image of the fetus may be sized to fit inside the image of the pregnant woman. In some embodiments, the program causes the computing device to provide the image of the pregnant woman with the corresponding image of the fetus to the display device for display.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for customizing pregnancy imagery, according to embodiments disclosed herein;

FIG. 2 depicts a user computing device for customizing pregnancy imagery, according to embodiments disclosed herein;

FIG. 3 depicts a user interface for providing options for image capture of a pregnant woman and fetus, according to embodiments disclosed herein;

FIG. 4 depicts a user interface for providing a first capture option to capture an image of a pregnant woman and a second capture option to capture a picture of a fetus, according to embodiments disclosed herein;

FIG. 5 depicts a user interface for providing options related to capturing an image of a pregnant woman, according to embodiments disclosed herein;

FIG. 6 depicts a user interface for providing an image of a pregnant woman, according to embodiments disclosed herein;

FIG. 7 depicts a user interface for providing the image of the pregnant woman, as well as options for providing an image of a fetus, according to embodiments disclosed herein;

FIG. 8 depicts a user interface for selecting an image type for the fetus, according to embodiments disclosed herein;

FIG. 9 depicts a user interface for providing the image of the pregnant woman with a generic image of the fetus, according to embodiments disclosed herein;

FIG. 10 depicts a user interface for providing a sonogram image of the fetus, according to embodiments disclosed herein;

FIG. 11 depicts a user interface for providing the sonogram image of the fetus with the image of the pregnant woman, according to embodiments disclosed herein; and

FIG. 12 depicts a flowchart for providing an image of a fetus with an image of a mother, according to embodiments disclosed herein.

### DETAILED DESCRIPTION OF THE INVENTION

Embodiments disclosed herein include systems and methods for customizing pregnancy imagery. More specifically, some embodiments disclosed herein are configured to receive an image of a pregnant woman. The image of the pregnant woman may include a captured still image, a stored still image, a real-time video image, a stored video image, and/or other type of image. Similarly, the image of the mother may be a 2-dimensional image, a 3-dimensional image, and/or a 4-dimensional image. Regardless, embodiments disclosed herein may also be configured to select an image of a fetus. The image of the fetus may be a generic fetus and/or an actual image of the fetus of the mother (such as via a sonogram image). The image of the fetus may similarly be a still image and/or a video image and may be 2-dimensional, 3-dimensional, and/or 4-dimensional. With the image of the pregnant woman and the image of the fetus, embodiments disclosed herein may adjust the sizes and orientations of the images, the image of the fetus is morphed into the midsection of the pregnant woman to provide the illusion that the user can see through the skin of the mother to view the fetus.

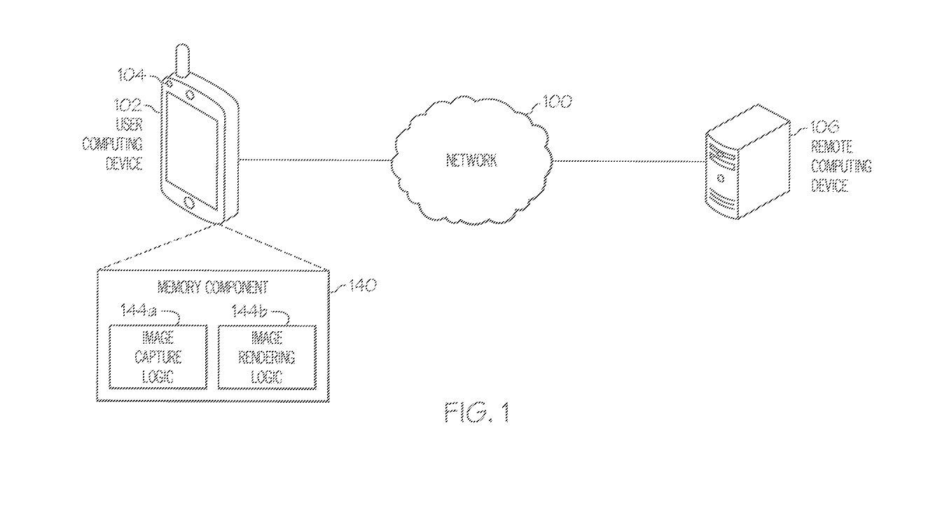

Referring now to the drawings, FIG. 1 depicts a computing environment for customizing pregnancy imagery, according to embodiments disclosed herein. As illustrated, a network 100 may be coupled to a user computing device 102 (which includes an image capture device 104) and a remote computing device 106. The network 100 may include a wide area network and/or a local area network and thus may be wired and/or wireless. The user computing device 102 may include any portable and/or non-portable computing devices, such as personal computers, laptop computers, tablet computers, personal digital assistants (PDAs), mobile phones, etc. As discussed in more detail below, the user computing device 102 may include a memory component 140 that stores image capture logic 144a and image rendering logic 144b. The image capture logic 144a may include software, hardware, and/or firmware for capturing, retrieving, and/or otherwise acquiring a still and/or video image of a pregnant woman and/or fetus. Similarly, the image rendering logic 144b may include software, hardware, and/or firmware for altering and/or combining an image of the pregnant woman with the image of the fetus. The image rendering logic 144b may also be configured to generate one or more user interfaces for providing the imagery, as well as related options and functionality described below.

Similarly, the remote computing device 106 may be configured as a server and/or other computing device for communicating information with the user computing device 102. In some embodiments, the remote computing device 106 may be configured to send and/or receive images related to a pregnant woman and/or fetus.

It should be understood that while the user computing device 102 and the remote computing device 106 are represented in FIG. 1 each as a single component; this is merely an example. In some embodiments, there may be numerous different components that provide the described functionality. However, for illustration purposes, single components are shown in FIG. 1 and described herein.

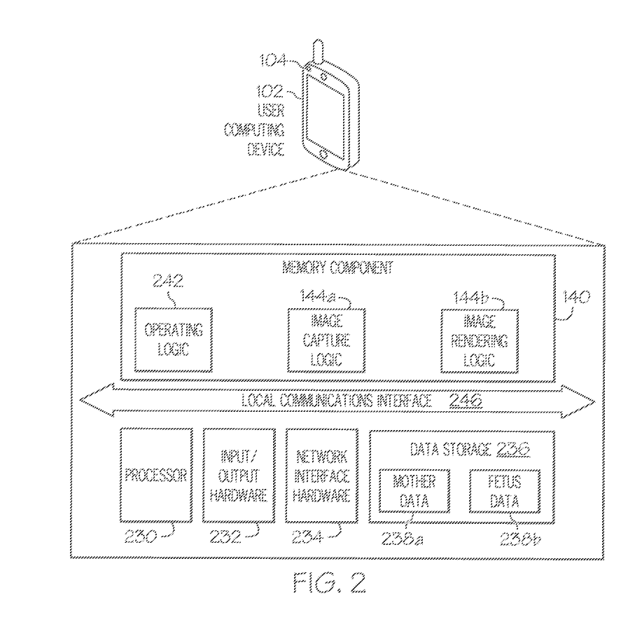

FIG. 2 depicts a user computing device 102 for customizing pregnancy imagery, according to embodiments disclosed herein. In the illustrated embodiment, the user computing device 102 includes a processor 230, input/output hardware 232, network interface hardware 234, a data storage component 236 (which stores mother data 238a, fetus data 238b, and/or other data), and the memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the user computing device 102 and/or external to the user computing device 102.

Additionally, the memory component 140 may store operating logic 242, the image capture logic 144a, and the image rendering logic 144b. The image capture logic 144a and the image rendering logic 144b may each include a plurality of different pieces of logic, each of which may be embodied as a computer program, firmware, and/or hardware, as an example. A local communication interface 246 is also included in FIG. 2 and may be implemented as a bus or other communication interface to facilitate communication among the components of the user computing device 102.

The processor 230 may include any processing component operable to receive and execute instructions (such as from the data storage component 236 and/or the memory component 140). The input/output hardware 232 may include and/or be configured to interface with a monitor, positioning system, keyboard, touch screen, mouse, printer, image capture device (such as the image capture device 104, which may include a still image camera, a video camera, a 2-dimensional camera, 3-dimensional camera, a 4-dimensional camera, and/or other image capturing hardware), microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the user computing device 102 and other computing devices.

The operating logic 242 may include an operating system and/or other software for managing components of the user computing device 102. Similarly, as discussed above, the image capture logic 144a may reside in the memory component 140 and may be configured to cause the processor 230 to capture, retrieve, and/or otherwise acquire images of a pregnant woman and a fetus. Similarly, the image rendering logic 144b may be configured for utilizing the imagery received from the image capture logic 144a to create an augmented reality and/or other interface that includes the image of the pregnant woman and the image of the fetus. Other functionality is also included and described in more detail, below.

It should be understood that the components illustrated in FIG. 2 are merely exemplary and are not intended to limit the scope of this disclosure. While the components in FIG. 2 are illustrated as residing within the user computing device 102, this is merely an example. In some embodiments, one or more of the components may reside external to the user computing device 102. It should also be understood that while the user computing device 102 in FIG. 2 is illustrated as a single device, this is also merely an example. In some embodiments, the image capture logic 144a and/or the image rendering logic 144b may reside on different devices. Additionally, while the user computing device 102 is illustrated with the image capture logic 144a and the image rendering logic 144b as separate logical components, this is also an example. In some embodiments, a single piece of logic may cause the user computing device 102 to provide the described functionality.

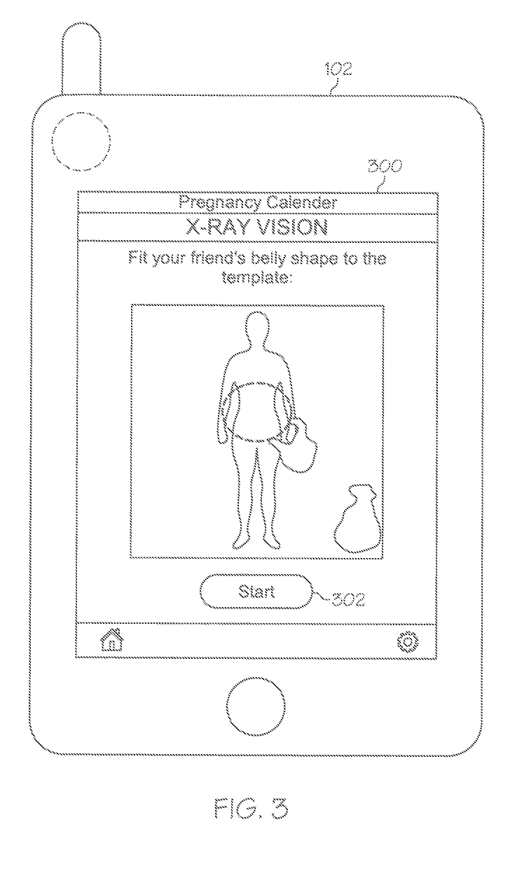

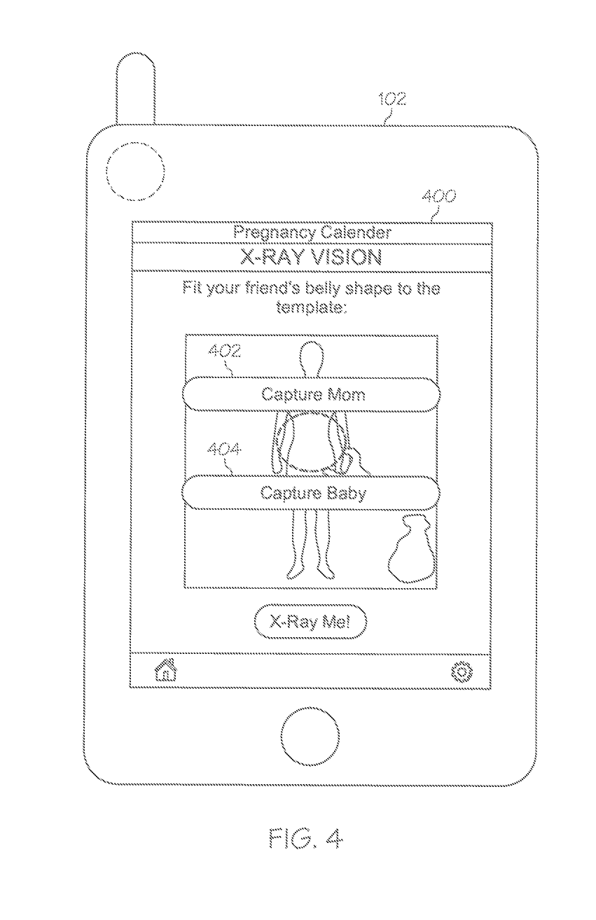

FIG. 3 depicts a user interface 300 for providing options for image capture of a pregnant woman and fetus, according to embodiments disclosed herein. As illustrated, the user computing device 102 may be configured to provide the user interface 300, which includes a banner page for indicating some of the functionality provided by the user computing device 102. Also included in the user interface 300 is a start option 302 for beginning the process of capturing images, as described with reference to FIG. 4.

FIG. 4 depicts a user interface 400 for providing a first capture option, such as the capture mom option 402 to capture an image of a pregnant woman and a second capture option, such as capture baby option 404 to capture a picture of a fetus, according to embodiments disclosed herein. As illustrated and described in more detail below, the capture mom option 402 may provide options for capturing an image of a pregnant woman, while the capture baby option 404 may provide options for capturing an image of a fetus.

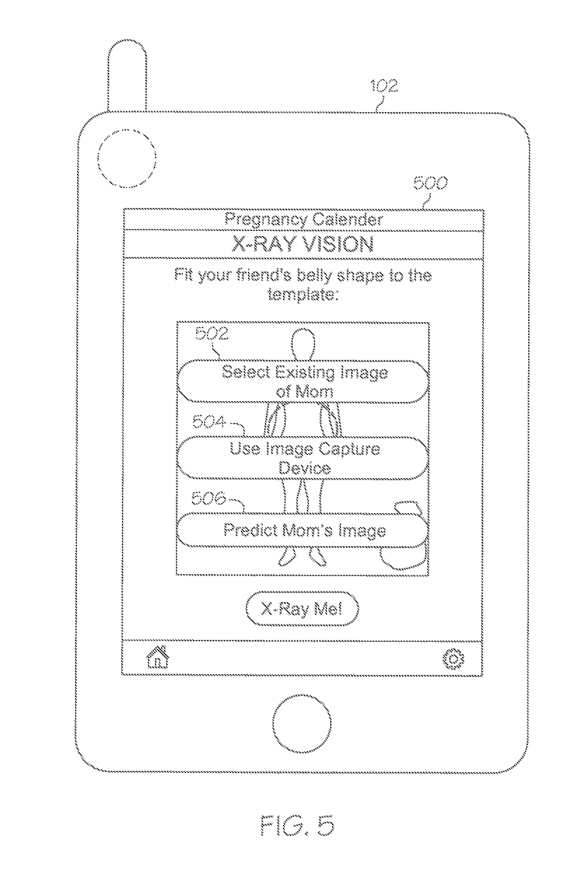

FIG. 5 depicts a user interface 500 for providing options related to capturing an image of a pregnant woman, according to embodiments disclosed herein. As illustrated, in response to selection of the capture mom option 402 from FIG. 4, the user interface 500 may be provided. The user interface 500 may include an existing image option 502, a capture image option 504, and a predict image option 506. More specifically, in response to selecting the existing image option 502, the user may be provided with an electronic folder that includes one or more existing images of pregnant women. The one or more existing images may include the pregnant women's midsection. Additionally, the stored image may be a still image, a video image, a 2-dimensional image, a 3-dimensional image, a 4-dimensional image, etc. Regardless, the image may be locally stored on the user computing device 102 and/or remotely stored on the remote computing device 106 (FIG. 1). Similarly, the capture image option 504 may also be provided in the user interface 500 and may be configured to activate the image capture device 104 (FIG. 1) to capture a still and/or video image of a pregnant woman.

Additionally, the predict image option 506 may also be included and may predict a woman's likeness based on past data. In some embodiments, the user computing device 102 may receive calendar data regarding the pregnant woman. The calendar data may include a conception date, a predicted due date, past imagery of the pregnant woman, past imagery of the fetus, and/or other data. With this information, the user computing device 102 may select and/or render an image (still, video, etc.), that predicts a likeness of the pregnant woman (or a generic pregnant woman) in her current gestational state and creates a predicted future image. The likeness may take the form of a photographic image of another pregnant woman at the predicted stage of development or a non-photographic representation of the pregnant woman. Additionally, in some embodiments, the predict image option 506 may additionally allow the user to select a date for the image prediction, which may be a past date, a current date, or a future date.

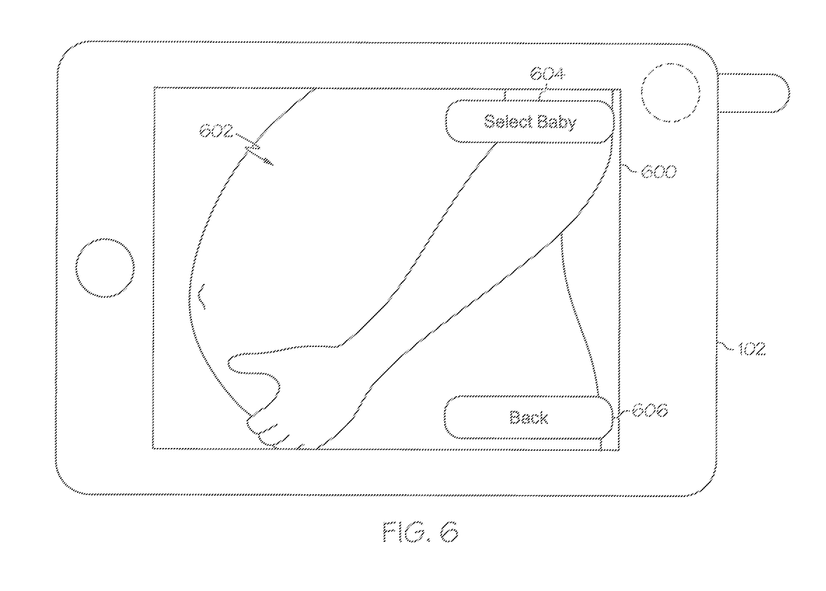

FIG. 6 depicts a user interface 600 for providing an image of a pregnant woman 602, according to embodiments disclosed herein. As illustrated, in response to selection of one of the options 502, 504, 506 from FIG. 5, the user computing device 102 may provide the user interface 600, which includes an image of a pregnant woman 602. As discussed above, the image may be a still image, a video image, etc and may portray the midsection of the pregnant woman. Also included is a select baby option 604 for selecting an image of the fetus. A back option 606 is also included to return to the user interface 500 (FIG. 5).

Additionally, in some embodiments, an option may be provided to determine a size of the image of the pregnant woman 602. Similarly, in some embodiments the user computing device 102 may automatically size the image of the pregnant woman 602 to adequately depict the image of the pregnant woman with a fetus.

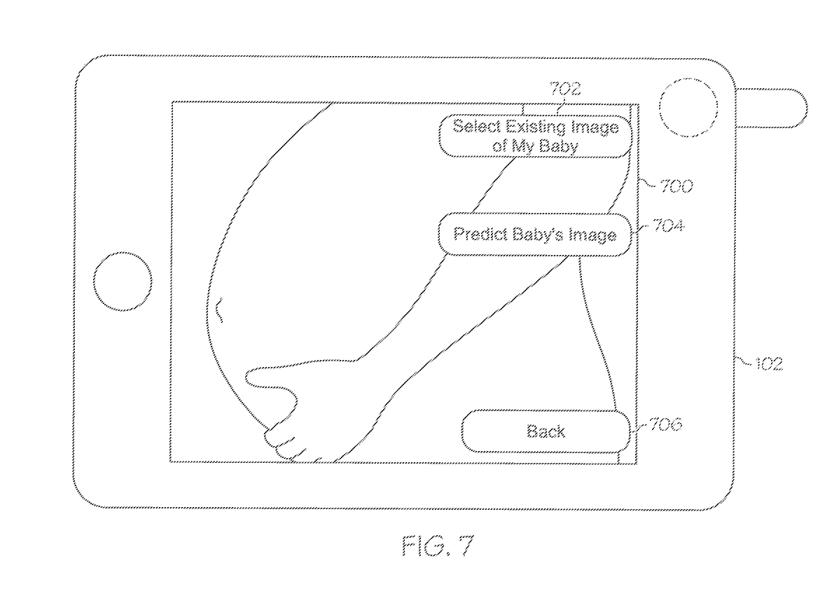

FIG. 7 depicts a user interface 700 for providing the image of the pregnant woman 602, as well as options for providing an image of a fetus, according to embodiments disclosed herein. As illustrated, in response to selecting the select baby option 604 (from FIG. 6), the user may be presented with an existing image option 702, a predicted image option 704, and a back option 706. As discussed in more detail below, in response to selection of the existing image option 702, the user may be provided with one or more options for selecting an image of the fetus. However, in response to selection of the predicted image option 704, the calendar data may again be accessed to determine a current stage of development of the fetus. The user computing device 102 may then select and/or generate a predicted image of the fetus. The predicted image of the fetus may be sized and shaped to adequately fit inside the womb depicted in the image of the pregnant woman 602 to appear as if the fetus is actually inside the pregnant woman and the user can see into the pregnant woman's womb.

It should be understood that while FIG. 7 is depicted as being presented after the image of the pregnant woman 602 is selected, this is merely an example. In some embodiments, the capture baby option 404 (FIG. 4) may be selected and the user interface 700 may be provided in response to that selection. In such embodiments, the user interface 500 (FIG. 5) may be provided after selection of the image of the fetus is complete.

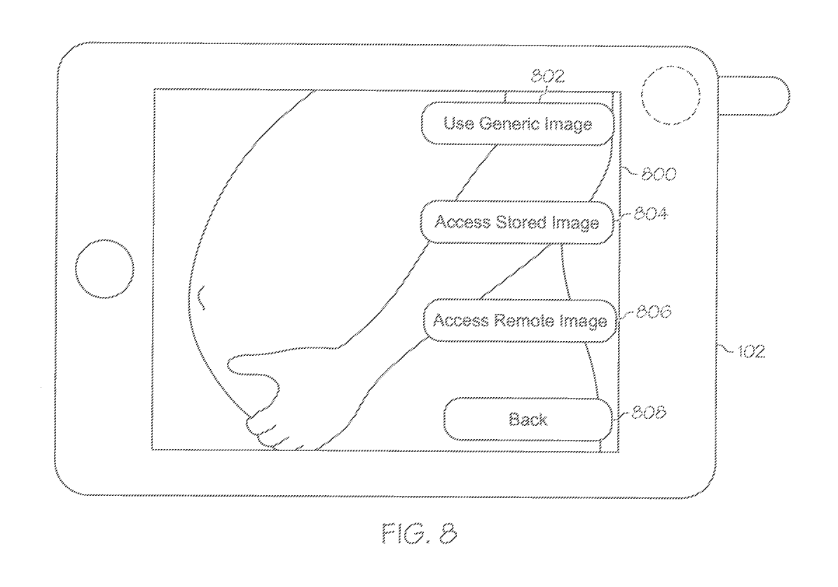

FIG. 8 depicts a user interface 800 for selecting an image type for the fetus, according to embodiments disclosed herein. As illustrated, in response to selection of the existing image option 702 (FIG. 7), the user interface 800 may be provided. The user interface 800 may include a generic image option 802, a stored image option 804, a remote image option 806, and a back option 808. In response to selection of the generic image option 802, the user computing device 102 may access, select, and/or render an image of a generic fetus at the current stage of development as the mother. The image may be a photographic image (still or video) and/or the image may be a rendering (still or animated) of the generic fetus.

Similarly, in response to selection of the stored image option 804, the user computing device 102 may access imagery stored locally on the user computing device 102. The imagery may include a 2-dimensional, 3-dimensional, and/or 4-dimensional sonogram image or other image of the fetus inside the womb. Similarly, in response to selection of the remote image option 806, the user computing device 102 may access similar imagery from the remote computing device 106 (FIG. 1).

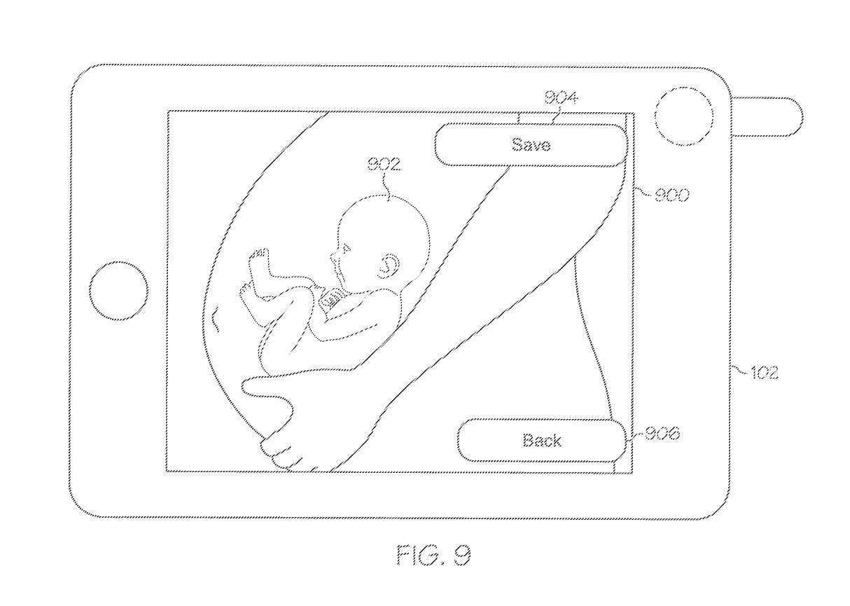

FIG. 9 depicts a user interface 900 for providing the image of the pregnant woman 602 with a generic image of the fetus 902, according to embodiments disclosed herein. As illustrated, in response to selection of the generic image option 802 from FIG. 8, the user computing device 102 may select a generic image of a fetus 902 to be inserted into the image of the pregnant woman 602. Additionally, an option may be provided to determine a size the image of the pregnant woman 602 and/or the generic image of the fetus 902 such that the generic image of the fetus 902 fits inside the womb of the pregnant woman, as if the generic fetus was actually inside the pregnant woman. In some embodiments, this sizing may be performed automatically by the user computing device 102. A save option 904 is included for saving the imagery of FIG. 9. A back option 906 is included to return to a previous user interface.

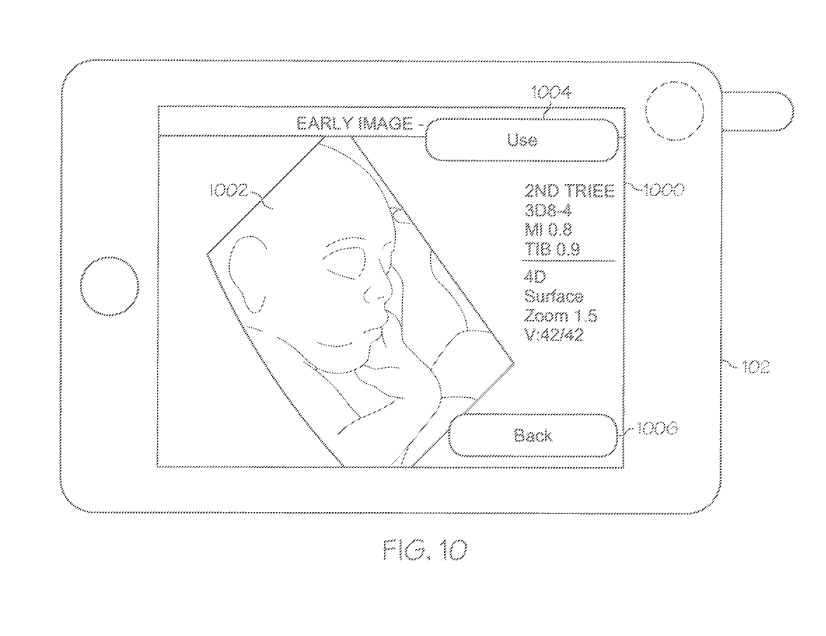

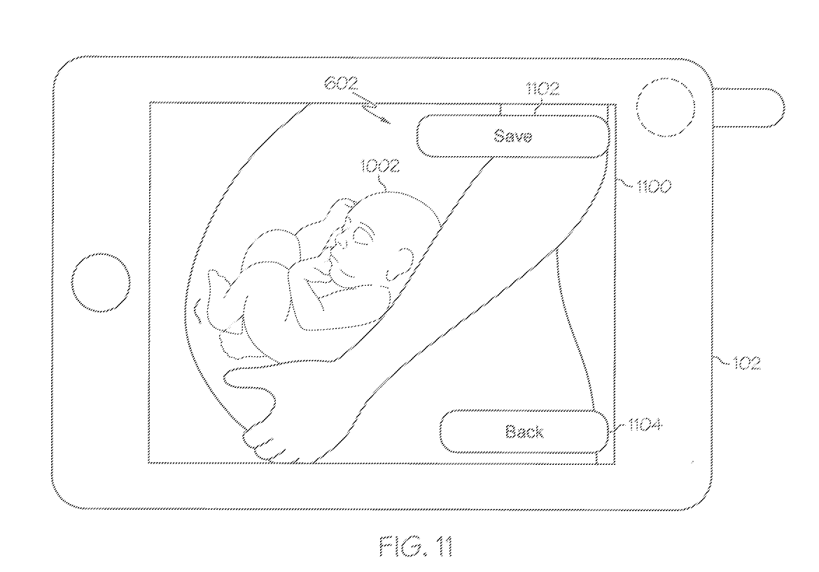

It should be understood that while the embodiment of FIG. 9 illustrates a 2-dimensional still image of the mother and fetus, this is merely an example. As discussed above, the generic image of the fetus 902 the image of the pregnant woman 602 may each be a still image and/or a video image and may be rendered in multiple different dimensions. Further, in some embodiments where the image of the pregnant woman 602 is a real-time video image (e.g. captured by the image capture device 104 of FIGS. 1 and 2), the user may continue to direct the image capture device 104 at the pregnant woman's midsection and rotate around the pregnant woman. In response, the user computing device 102 can rotate both the real-time image of the pregnant woman, as well as the generic image of the fetus 902. Such an embodiment provides the illusion that the user can actually see inside the womb of the pregnant woman to see the generic image of the fetus 902. Similar functionality may be utilized for an actual image of the fetus, such as from FIGS. 10 and 11, described below and/or with a generic image of the pregnant woman, as described above.

It should also be understood that while not explicitly stated above, in some embodiments the user computing device 102 may additionally determine a marker on the pregnant woman to determine an orientation of the image of the pregnant woman 602 in the image capture device 104. In so doing, the user computing device 102 may utilize the marker, such as a hand, bellybutton, shape, color, and/or other identifier of a position on the pregnant woman's midsection that signifies an orientation. With the orientation information, the user computing device 102 may additionally determine a marker on the fetus and thus determine an orientation of the generic image of the fetus 902 and substantially align the generic image of the fetus 902 with the image of the pregnant woman 602. With the orientation information of the pregnant woman and the fetus, one or more of the images may be altered to accurately portray the fetus inside the womb. Additionally, if information regarding the position of the fetus is available, this information may additionally be utilized for this purpose. Thus, in embodiments where the image of the pregnant woman is a video image, the user computing device 102 can detect motion of the user computing device 102 around the pregnant woman and alter the generic image of the fetus 902 according to changes in position of the image. Similar functionality may also be applied to a sonogram image of the fetus 1002, described with reference to FIG. 10.

FIG. 10 depicts a user interface 1000 for providing a sonogram image of the fetus 1002, according to embodiments disclosed herein. As illustrated, the user computing device 102 may be configured to access actual imagery of the pregnant woman's fetus. This imagery may be stored locally on the user computing device 102 and/or remotely on the remote computing device 106 (FIG. 1). Regardless, in response to selecting the existing image option 702 (FIG. 7), the user may be provided with the image of the fetus 1002 (and/or other images). If the user desires to utilize the image of the fetus 1002, the user may select a use option 1004. Also included is a back option 1006 to return to a previous user interface.

FIG. 11 depicts a user interface 1100 for providing the sonogram image of the fetus 1002 (FIG. 10) with the image of the pregnant woman 602 (FIG. 6), according to embodiments disclosed herein. As illustrated, in response to selecting the use option 1004 (FIG. 10) and/or selecting the image of the pregnant woman 602, the user interface 1100 may be provided. As discussed above with the generic image of the fetus 902 (FIG. 9), the images may be sized, shaped, and oriented to fit together as if the fetus was actually inside the woman's womb. Additionally, a marker may be used on the pregnant woman and/or the image of the fetus 1002 to assist in this coordination. As an example, the user computing device 102 may determine the bellybutton of the pregnant woman and use that marker to orient the image of the pregnant woman. Similarly, a marker on the image of the fetus (such as a face, umbilical cord, metadata from the sonogram, etc.) may also be determined to coordinate the images. Also included is a save option 1102 for saving the imagery. A back option 1104 is included to return to a previous user interface.

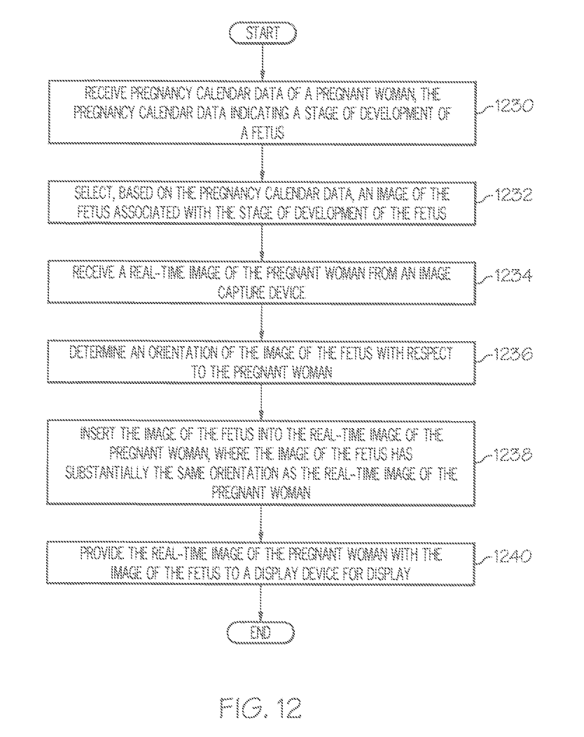

FIG. 12 depicts a flowchart for providing an image of a fetus with an image of a mother, according to embodiments disclosed herein. As illustrated in block 1230, pregnancy calendar data of a pregnant woman may be received, where the pregnancy calendar data indicates a stage of development of a fetus. In block 1232, a selection of an image of the fetus may be made. The selection may be made based on the pregnancy data and the image of the fetus may correspond with the stage of development of the fetus. In block 1234, a real-time image of the pregnant woman may be received from the image capture device 104. In block 1236, an orientation of the image of the fetus may be determined with respect to an orientation of the pregnant woman. In block 1238, the image of the fetus may be inserted into the real-time image of the pregnant woman, where the image of the fetus has substantially the same orientation as the real-time image of the pregnant woman. In block 1240, the real-time image of the pregnant woman may be provided with the image of the fetus to a display device for display.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for customizing pregnancy imagery, comprising:
(a) an image capture device;
(b) a display device; and
(c) a memory component that stores logic that when executed by the system, causes the system to perform at least the following:
(i) receive pregnancy calendar data of a pregnant woman, the pregnancy calendar data indicating a stage of development of a fetus;
(ii) select, based on the pregnancy calendar data, an image of the fetus associated with the stage of development of the fetus;
(iii) receive an image of the pregnant woman from the image capture device;
(iv) determine a relative size of the image of the fetus with regard to the image of the pregnant woman;
(v) determine an orientation of the image of the fetus with respect to the pregnant woman;
(vi) insert the image of the fetus into the image of the pregnant woman, wherein the image of the fetus has substantially the same orientation as the image of the pregnant woman, and wherein the relative size of the image of the fetus is such that the image of the fetus fits inside the image of the pregnant woman; and
(vii) provide the image of the pregnant woman with the image of the fetus to the display device for display.

2. The system of claim 1, wherein the image of the fetus comprises at least one of the following: a rendering of a generic fetus received from a remote computing device and a sonogram image of the fetus.

3. The system of claim 1, wherein determining the orientation of the image of the fetus with respect to the pregnant woman comprises utilizing the image capture device to locate a marker on the pregnant woman to determine the orientation.

4. The system of claim 1, wherein the logic further causes the system to perform at least the following:
(a) detect motion of the image capture device; and
(b) alter the image of the fetus to correspond with the motion.

5. The system of claim 1, wherein the logic further causes the system to provide a user interface that provides an option for viewing at least one of the following: a past image of the fetus, a predicted future image of the fetus, a past image of the pregnant woman, and a predicted future image of the pregnant woman.

6. The system of claim 1, wherein the logic further causes the system to provide a user interface that provides an option for determining a size of the image of the pregnant woman such that the relative size of the image of the fetus is such that the image of the fetus fits inside the image of the pregnant woman.

7. The system of claim 1, wherein the image of the pregnant woman is a real-time video image received from the image capture device.

8. A method for customizing pregnancy imagery, comprising:
(a) receiving pregnancy calendar data of a pregnant woman, the pregnancy calendar data indicating a stage of development of a fetus;
(b) selecting, based on the pregnancy calendar data, an image of the fetus associated with the stage of development of the fetus;
(c) receiving a real-time image of the pregnant woman from an image capture device;
(d) determining an orientation of the image of the fetus with respect to the pregnant woman;
(e) inserting the image of the fetus into the real-time image of the pregnant woman, wherein the image of the fetus has substantially the same orientation as the real-time image of the pregnant woman; and
(f) providing, by a computing device, the real-time image of the pregnant woman with the image of the fetus to a display device for display.

9. The method of claim 8, wherein the image of the fetus comprises at least one of the following: a rendering of a generic fetus received from a remote computing device and a sonogram image of the fetus.

10. The method of claim 8, wherein determining the orientation of the image of the fetus with respect to the pregnant woman comprises locating a marker on the pregnant woman to determine the orientation.

11. The method of claim 8, further comprising:
(g) detecting motion of the image capture device;
(h) altering the real-time image of the pregnant woman to correspond with the motion; and
(i) altering the image of the fetus to correspond with the motion.

12. The method of claim 8, further comprising providing a user interface that provides an option for viewing at least one of the following: a past image of the fetus, a predicted future image of the fetus, a past image of the pregnant woman, and a predicted future image of the pregnant woman.

13. The method of claim 8, further comprising providing a user interface that provides an option for determining a size of the real-time image of the pregnant woman.

14. A non-transitory computer-readable medium for customizing pregnancy imagery that stores a program that when executed by a computing device, causes the computing device to perform at least the following:
(a) receive pregnancy calendar data of a pregnant woman, the pregnancy calendar data indicating a stage of development of a fetus;
(b) determine from the pregnancy calendar data whether a corresponding image of the fetus is available;
(c) in response to determining that the corresponding image of the fetus is not available:
(d) select an image of a generic fetus associated with the stage of development;
(e) receive an image of the pregnant woman from an image capture device;
(f) determine an orientation of the image of the generic fetus with respect to the pregnant woman;
(g) insert the image of the generic fetus into the image of the pregnant woman, wherein the image of the generic fetus has substantially the same orientation as the image of the pregnant woman; and
(h) provide the image of the pregnant woman with the image of the generic fetus to a display device for display.

15. The non-transitory computer-readable medium of claim 14, wherein the corresponding image of the fetus comprises a sonogram image of the fetus.

16. The non-transitory computer-readable medium of claim 14, wherein determining the orientation of the image of the generic fetus with respect to the pregnant woman comprises utilizing the image capture device to locate a marker on the pregnant woman to determine the orientation.

17. The non-transitory computer-readable medium of claim 14, wherein the program further causes the computing device to perform at least the following:
detect motion of the image capture device; and
alter the image of the generic fetus to correspond with the motion.

18. The non-transitory computer-readable medium of claim 14, wherein the program further causes the computing device to provide at least one of the following:
a first user interface that provides a first user option for viewing at least one of the following:
a past image of the fetus, a predicted future image of the fetus, a past image of the pregnant woman, and a predicted future image of the pregnant woman; and
a second user interface that provides a second user option for determining a size of the image of the pregnant woman.

19. The non-transitory computer-readable medium of claim 14, wherein in response to determining that the corresponding image of the fetus is available, the program causes the computing device to perform at least the following:
(a) receive the corresponding image of the fetus;
(b) receive an image of the pregnant woman from the image capture device;
(c) determine an orientation of the corresponding image of the fetus with respect to the pregnant woman;
(d) insert the image of the corresponding image of the fetus into the image of the pregnant woman, wherein the corresponding image of the fetus has substantially the same orientation as the image of the pregnant woman, and wherein the corresponding image of the fetus is sized to fit inside the image of the pregnant woman; and
(e) provide the image of the pregnant woman with the corresponding image of the fetus to the display device for display.

20. The non-transitory computer-readable medium of claim 14, wherein the image of the pregnant woman is a real-time video image received from the image capture device.
